(19) United States
(12) Patent Application Publication
(10) Pub. No.: US 2020/0236958 A1
(43) Pub. Date: Jul. 30, 2020

(54) FROZEN VEGETABLE

(71) Applicant: Nichirei Foods Inc., Tokyo (JP)

(72) Inventors: Kosuke YAMADA, Chiba-shi (JP); Ippei NAKAYAMA, Chiba-shi (JP); Hiroyasu ISHIGURO, Chiba-shi (JP)

(73) Assignee: Nichirei Foods Inc., Tokyo (JP)

(21) Appl. No.: 16/489,073

(22) PCT Filed: Feb. 27, 2018
(86) PCT No.: PCT/JP2018/007160

§ 371 Date: Aug. 27, 2019

(30) Foreign Application Priority Data
Feb. 28, 2017 (JP) 2017-037564

(51) Int. Cl. A23B 7/045; A23L 27/00

(52) U.S. Cl. CPC A23B 7/045; A23L 19/00; A23L 27/88

(57) ABSTRACT

Disclosed is a frozen vegetable subjected to dry heat treatment prior to freezing, the frozen vegetable exhibiting a drip loss during natural thawing of 7.20% or less, the frozen vegetable exhibiting a change in bulk density relative to fresh product of 1.90 or less. The frozen vegetable of the present invention is useful in that the frozen vegetable presents appealing voluminosity, generates little drip, is free of wateriness, and has crunchy texture.

### CROSS-REFERENCE TO RELATED APPLICATION

This patent application claims priority based on Japanese Patent Application No. 2017-37564, which is an earlier patent application filed in Japan on Feb. 28, 2017. The disclosure of this earlier patent application is incorporated herein by reference in its entirety.

### BACKGROUND OF THE INVENTION

### Technical Field

The present invention relates to frozen vegetables.

### Background Art

In general, frozen and thawed vegetables are soft and wilted because of water loss occurring during thawing and lack visual freshness, thus decreasing appetite. Such vegetables are visually small in volume and have watery taste, and this significantly diminishes the added value given to the frozen vegetables. Additionally, conventional frozen vegetables readily release water during heating when they are cooked in a temperature range above the boiling point, such as when they are sautéed, baked, or fried. Thus, there is a problem in that the latent heat of vaporization of water causes cooling of the surroundings and makes it difficult to achieve quick cooking at high temperature.

In order for frozen vegetables to have good texture after thawing or cooking, the following methods have been reported: a method in which onion is dried by heating at high temperature before freezing (Patent Document 1); a method in which onion or carrot is roasted at 40 to 70° C. without the use of any fat or oil (Patent Document 2); a method in which potato is treated at high temperature and heat-treated in a calcium-containing aqueous solution before freezing (Patent Document 3); a method in which carrot is dried, before freezing, to the extent that heat does not transfer to the inside of the carrot (Patent Document 4); and a method in which onion is treated with hot water before freezing (Patent Document 7). However, even treatment using any of these methods still leaves the problems of generation of a large amount of drip and decrease in volume upon thawing of frozen vegetables. There have also been reported a method in which daikon radish is slowly frozen, then thawed, and dried and dehydrated before final freezing (Patent Document 5) and a method in which bean sprout, paprika, and pumpkin are dried and dehydrated before freezing (Patent Documents 6 and 8). The vegetables treated by these methods lose a considerable amount of water and lose the intrinsic nature of the vegetables.

### PRIOR ART DOCUMENT

### Patent Document

Patent Document 1: Japanese Patent Laid-Open No. 7-147892
Patent Document 2: Japanese Patent Laid-Open No. 7-250643
Patent Document 3: Japanese Patent Laid-Open No. 8-140570
Patent Document 4: Japanese Patent Laid-Open No. 2005-143366
Patent Document 5: Japanese Patent Laid-Open No. 2007-275031
Patent Document 6: Japanese Patent Laid-Open No. 2008-271934
Patent Document 7: Japanese Patent Laid-Open No. 2011-91
Patent Document 8: Japanese Patent Laid-Open No. 2015-39339

### SUMMARY OF THE INVENTION

The present inventors have found for frozen vegetables subjected to freezing after dry heat treatment that a frozen vegetable exhibiting a certain drip loss during natural thawing and a certain change in bulk density presents appealing voluminosity, generates little drip, is free of wateriness, and exhibits crunchy texture. The present invention is based on this finding.

It is therefore an object of the present invention to provide a frozen vegetable that presents appealing voluminosity, generates little drip, is free of wateriness, and exhibits crunchy texture.

That is, the present invention provides the following.

(1) A frozen vegetable subjected to dry heat treatment prior to freezing, the frozen vegetable exhibiting a drip loss during natural thawing of 7.20% or less, the frozen vegetable exhibiting a change in bulk density relative to fresh product of 1.90 or less, wherein

the drip loss during natural thawing is defined by the following equation:

Drip loss during natural thawing (%)=Weight of drip during natural thawing (g)/Weight of frozen product (g)×100, and

the change in bulk density relative to fresh product is defined by the following equation:

Change in bulk density relative to fresh product=Bulk density exclusive of drip after natural thawing (g/ml)/Bulk density of fresh vegetable prepared by processing of raw material (g/ml).

(2) The frozen vegetable according to (1), wherein the drip loss during natural thawing is 4.70% or less.
(3) The frozen vegetable according to (1) or (2), wherein the change in bulk density relative to fresh product is 1.80 or less.
(4) The frozen vegetable according to any one of (1) to (3), for cooking.
(5) A frozen food comprising the frozen vegetable according to any one of (1) to (4).
(6) The frozen food according to (5), further comprising an ingredient and/or a flavoring component.

The frozen vegetable of the present invention is advantageous in that reduction in water loss and maintenance of volume can be achieved when the frozen vegetable is thawed. The present invention is advantageous in that a frozen vegetable that presents appealing voluminosity, generates little drip, is free of wateriness, and exhibits crunchy texture can be provided. The present invention is advantageous in that a frozen vegetable offering the intrinsic sweetness or flavor of the vegetable and superior in taste can be provided.

The frozen vegetable of the present invention is advantageous in that post-cooking quality comparable to that of an unfrozen fresh vegetable can be achieved. Specifically, the frozen vegetable is advantageous in that, despite being a frozen product, it can be cooked relatively quickly because of having a sufficient volume, having good shape retention and solid property, and generating little drip. More specifically, the frozen vegetable of the present invention is advantageous in that when cooked in a temperature range above the boiling point, such as when sautéed, baked, or fried, the frozen vegetable can, due to its shape retention ability and water retention ability, achieve a sautéed or roasted state comparable in quality to that achievable by unfrozen products. The frozen vegetable of the present invention is advantageous also in that, thanks to the maintenance of volume, the temperature of the vegetable's surface portion in contact with a heating medium increases relatively quickly while the temperature of the inside of the vegetable increases in a delayed fashion. This effect is advantageous in that a preferred flavor-giving reaction (Maillard reaction) occurring at high temperature proceeds in the surface portion of the vegetable while the damage caused by long-time cooking to the vegetable can be minimized as a whole. Thus, the present invention is advantageous in that high-quality, high-utility frozen vegetables for cooking can be provided.

### BRIEF DESCRIPTION OF THE DRAWINGS

FIG. 1 is a photograph, taken from the side, of a cooked product prepared by cooking frozen bell pepper according to (3)(i) of Example 1, the frozen bell pepper being one which was prepared according to (1)(iii) of Example 1 and test batch 7 in Table 1 shown in (4) of Example 1, except that bell pepper with an average pericarp thickness of 2 mm was vertically cut into halves, the halves were cut into 10-mm-wide strips, and the strips were washed and drained;

FIG. 2 is a photograph, taken from the side, of a cooked product prepared by cooking frozen bell pepper according to (3)(i) of Example 1, the frozen bell pepper being one which was prepared according to (1)(i) of Example 1 and test batch 4 in Table 1 shown in (4) of Example 1, except that bell pepper with an average pericarp thickness of 2 mm was vertically cut into halves, the halves were cut into 10-mm-wide strips, and the strips were washed and drained;

FIG. 3 is a photograph, taken obliquely from above, of a cooked product prepared by weighing 100 g of frozen bell pepper prepared according to (1)(iii) of Example 1 and test batch 7 in Table 1 shown in (4) of Example 1 and 100 g of frozen onion prepared according to (1)(i) of Example 2 and test batch 15 in Table 2 shown in (4) of Example 2 and by cooking the weighed frozen bell pepper and frozen onion together according to (3)(i) of Example 1; and

FIG. 4 is a photograph, taken obliquely from above, of a cooked product prepared by weighing 100 g of frozen bell pepper prepared according to (1)(i) of Example 1 and test batch 3 in Table 1 shown in (4) of Example 1 and 100 g of frozen onion prepared according to (1)(i) of Example 2 and test batch 11 in Table 2 shown in (4) of Example 2 and by cooking the weighed frozen bell pepper and frozen onion together according to (3)(i) of Example 1.

### DETAILED DESCRIPTION OF THE INVENTION

The term “frozen vegetable” as used in the present invention refers to a vegetable frozen in such a manner that the thawed vegetable can be eaten as it is or after cooking. The frozen vegetable of the present invention may, before freezing, be cut into pieces of appropriate size for subsequent cooking (bite-sized pieces, for example) according to common general knowledge in the art.

The frozen vegetable of the present invention has been subjected to dry heat treatment prior to freezing. The frozen vegetable exhibits a drip loss during natural thawing of 7.20% or less and exhibits a change in bulk density relative to fresh product of 1.90 or less. The frozen vegetable with these features presents appealing voluminosity, generates little drip, is free of wateriness, and has crunchy texture. A product resulting from cooking of the frozen vegetable can achieve post-cooking quality comparable to that of an unfrozen fresh vegetable.

The “drip loss during natural thawing” in the present invention is defined by the following equation:

Drip loss during natural thawing (%)=Weight of drip during natural thawing (g)/Weight of frozen product (g)×100.

The weight of frozen product (g) and the weight of drip during natural thawing (g) are measured by the following procedures:

(i) A frozen vegetable as a sample is weighed to 200 g, which is used as the weight of frozen product (g),

(ii) the weighed sample is placed into a plastic bag and the plastic bag is sealed, with the thickness of the resulting package being less than 5 cm,

(iii) the sample is naturally thawed by leaving the sealed plastic bag at room temperature for 100 minutes while applying air to the plastic bag at a flow rate of 1 to 3 m/s by means of a fan (a floor-type circulator, KJ-4071 manufactured by Twinbird Corporation),

(iv) the whole of the naturally thawed sample is put on a mesh (opening size: 5.8 mm) placed over a bowl, the sample is inverted about every 5 minutes so as to prevent water from remaining on top of the sample, and the sample is thus separated into solids remaining on the mesh and water dropped into the bowl through the mesh, and

(v) the weight of water dropped into the bowl is measured as the weight of drip during natural thawing (g).

The “change in bulk density relative to fresh product” in the present invention is defined by the following equation:

Change in bulk density relative to fresh product=Bulk density exclusive of drip after natural thawing (g/ml)/Bulk density of fresh vegetable prepared by processing of raw material (g/ml).

The bulk density exclusive of drip after natural thawing (g/ml) is measured by the following procedures:

(i) A frozen vegetable as a sample is weighed to 200 g,

(ii) the weighed sample is placed into a plastic bag and the plastic bag is sealed, with the thickness of the resulting package being less than 5 cm,

(iii) the sample is naturally thawed by leaving the sealed plastic bag at room temperature for 100 minutes while applying air to the plastic bag at a flow rate of 1 to 3 m/s by means of a fan (a floor-type circulator, KJ-4071 manufactured by Twinbird Corporation),

(iv) the whole of the naturally thawed sample is put on a mesh (opening size: 5.8 mm) placed over a bowl, the sample is inverted about every 5 minutes so as to prevent water from remaining on top of the sample, and the sample is thus separated into solids remaining on the mesh and water dropped into the bowl through the mesh,

(v) the solids remaining on the mesh are placed in a 200-ml beaker (a heat-resistant measuring cup with a volume of 200 ml, manufactured by Pearl Metal Co., Ltd.) so as to fill the beaker up to the brim while the beaker is tapped against a table (while the bottom of the beaker is repeatedly brought into gentle contact with the top surface of the table), the weight of the solids filling the beaker is measured, this weight measurement is repeated three times, and the average of the three measurements is calculated,

(vi) the weight of water filling this beaker up to the brim at room temperature is measured, and

(vii) the average of the three measurements of the weight of the solids is divided by the weight of water, and the resulting value is used as the bulk density exclusive of drip after natural thawing of the frozen vegetable.

The bulk density of fresh vegetable prepared by processing of raw material (g/ml) is measured by the following procedures:

(i) A fresh vegetable sample corresponding to the above frozen vegetable sample is cut into the same shape as the frozen vegetable sample,

(ii) the cut sample is placed in a 200-ml beaker (a heat-resistant measuring cup with a volume of 200 ml, manufactured by Pearl Metal Co., Ltd.) so as to fill the beaker up to the brim while the beaker is tapped against a table (while the bottom of the beaker is repeatedly brought into gentle contact with the top surface of the table), the weight of the fresh vegetable filling the beaker is measured, this weight measurement is repeated three times, and the average of the three measurements is calculated,

(iii) the weight of water filling this beaker up to the brim at room temperature is measured, and

(iv) the average of the three measurements of the weight of the fresh vegetable is divided by the weight of water, and the resulting value is used as the bulk density of fresh vegetable.

For the frozen vegetable of the present invention, the drip loss during natural thawing is 7.20% or less, preferably 4.70% or less, and more preferably 3.79% or less.

For the frozen vegetable of the present invention, the change in bulk density relative to fresh product is 1.90 or less, preferably 1.80 or less, and more preferably 1.78 or less.

Examples of the vegetable used as the raw material of the frozen vegetable of the present invention include, but are not particularly limited to: fruit vegetables such as bell pepper, paprika (e.g., red paprika and yellow paprika), zucchini, bitter gourd, and eggplant; stem vegetables such as onion, Welsh onion, field mustard, asparagus, celery, and garlic sprout; root vegetables such as carrot, dalkon radish, turnip, and burdock root; flower vegetables such as broccoli and cauliflower; bean vegetables such as fava bean, green pea, and common bean; leaf vegetables such as cabbage, Chinese cabbage, qing-geng-cai, spinach, and Japanese mustard spinach; and mushrooms such as shiitake mushroom, enokitake mushroom, brown beech mushroom, common mushroom, and cloud ear mushroom.

According to a preferred embodiment of the present invention, the vegetable used as the raw material of the frozen vegetable of the present invention is bell pepper, onion, carrot, or cabbage.

According to another preferred embodiment of the present invention, the vegetable used as the raw material of the frozen vegetable of the present invention is bell pepper, red paprika, yellow paprika, zucchini, bitter gourd, onion, carrot, or cabbage.

The way of packaging the frozen vegetable of the present invention is not particularly limited and may be any common way of packaging frozen vegetables. For example, the frozen vegetable of the present invention may be packed in a bag or box.

In production of the frozen vegetable of the present invention, various conditions can be adjusted so that the frozen vegetable will exhibit the above-described drip loss during natural thawing and the above-described change in bulk density relative to fresh product. The details of the production method are not particularly limited. For example, the frozen vegetable can be produced by processing a fresh vegetable as a raw material, subjecting the processed vegetable to dry heat treatment, and then freezing the vegetable.

In the raw material processing step, the fresh vegetable as a raw material may, before freezing, be cut into pieces of appropriate size for subsequent cooking (bite-sized pieces, for example) according to common general knowledge in the art. If necessary, the fresh vegetable may be washed and drained.

For the dry heat treatment, appropriate treatment conditions can be selected within the temperature range of 40 to 75° C. and the time range of 5 to 300 minutes in view of the water content, water retention ability, and shape retention ability of the vegetable as a raw material.

According to another embodiment, appropriate treatment conditions for the dry heat treatment can be selected within the temperature range of 35 to 140° C. and the time range of 0.5 to 300 minutes in view of the water content, water retention ability, and shape retention ability of the vegetable as a raw material.

For example, when frozen bell pepper is produced, frozen bell pepper of the present invention which satisfies the predetermined requirements as to the drip loss during natural thawing and the change in bulk density relative to fresh product can be produced by performing heating with an oven maintained at 40 to 70° C. for 5 to 200 minutes before freezing.

Frozen bell pepper of the present invention which satisfies the predetermined requirements as to the drip loss during natural thawing and the change in bulk density relative to fresh product can be produced also by performing heating with a jet oven maintained at 120 to 140° C. for 0.5 to 2.5 minutes before freezing.

When frozen onion is produced, frozen onion of the present invention which satisfies the predetermined requirements as to the drip loss during natural thawing and the change in bulk density relative to fresh product can be produced by performing heating with an oven maintained at 60 to 75° C. for 5 to 90 minutes before freezing.

Frozen onion of the present invention which satisfies the predetermined requirements as to the drip loss during natural thawing and the change in bulk density relative to fresh product can be produced also by performing heating with a jet oven maintained at 110 to 130° C. for 1.5 to 3.5 minutes before freezing.

When frozen carrot is produced, frozen onion of the present invention which satisfies the predetermined requirements as to the drip loss during natural thawing and the change in bulk density relative to fresh product can be produced by performing heating with an oven maintained at 55 to 65° C. for 5 to 50 minutes before freezing.

When frozen cabbage is produced, frozen onion of the present invention which satisfies the predetermined requirements as to the drip loss during natural thawing and the change in bulk density relative to fresh product can be produced by performing heating with an oven maintained at 55 to 65° C. for 5 to 30 minutes before freezing.

When frozen red paprika is produced, frozen red paprika of the present invention which satisfies the predetermined requirements as to the drip loss during natural thawing and the change in bulk density relative to fresh product can be produced by performing heating with an oven maintained at 35 to 45° C. for 30 to 150 minutes before freezing.

When frozen yellow paprika is produced, frozen yellow paprika of the present invention which satisfies the predetermined requirements as to the drip loss during natural thawing and the change in bulk density relative to fresh product can be produced by performing heating with an oven maintained at 35 to 45° C. for 30 to 150 minutes before freezing.

When frozen zucchini is produced, frozen zucchini of the present invention which satisfies the predetermined requirements as to the drip loss during natural thawing and the change in bulk density relative to fresh product can be produced by performing heating with an oven maintained at 60 to 100° C. for 5 to 50 minutes before freezing.

When frozen bitter gourd is produced, frozen bitter gourd of the present invention which satisfies the predetermined requirements as to the drip loss during natural thawing and the change in bulk density relative to fresh product can be produced by performing heating with an oven maintained at 60 to 100° C. for 5 to 50 minutes before freezing.

The step of freezing the vegetable in the production method of the present invention can be carried out using any of various apparatuses known to persons skilled in the art, such as an individual quick freezing (IQF) apparatus, an air-blast freezer, a contact freezer, and a spray freezer. The temperature set for freezing of the vegetable varies depending on, for example, the type and quality of the vegetable, and is typically −18° C. or lower and preferably −35° C. or lower. The intensity of the freezing of the vegetable varies depending on the type and amount of the vegetable used and may be typically such that the central temperature of the vegetable decreases to −5° C. or lower within 30 minutes after the vegetable is placed in the freezer.

The frozen vegetable of the present invention can be used as a material of a frozen food. Thus, another aspect of the present invention provides a frozen food including the frozen vegetable of the present invention. Such a frozen food is not limited to any particular one as long as the frozen food includes the frozen vegetable of the present invention. Examples of the frozen food include: mixed vegetable foods including the frozen vegetable of the present invention; tsukemono or pickles prepared by mixing the frozen vegetable of the present invention and flavoring components; and articles including a set of the frozen vegetable of the present invention, other ingredients (such as meet, seafood, and other vegetables), and flavoring components.

The frozen food of the present invention can be produced by a known production method using materials similar to those of known frozen foods, except for the use of the frozen vegetable of the present invention.

The frozen food of the present invention may be packaged. The way of packaging is not particularly limited and may be any common way of packaging frozen vegetables. For example, the frozen food is packed in a bag or box.

According to a preferred embodiment of the present invention, the frozen vegetable of the present invention is a frozen vegetable for cooking. According to a preferred embodiment of the present invention, the frozen food of the present invention is a frozen food for cooking. Notably, the examples described later have demonstrated that the frozen vegetable of the present invention exhibits a surprisingly good texture when cooked at a temperature higher than the boiling point, in particular when sautéed. Thus, it is advantageous that the frozen vegetable or frozen food of the present invention be a frozen vegetable or frozen food to be cooked at a temperature higher than the boiling point, and it is particularly advantageous that the frozen vegetable or frozen food of the present invention be a frozen vegetable or frozen food to be sautéed.

The frozen vegetable or frozen food of the present invention can be used in households and can also be used for business purposes, such as in kitchens of restaurants, lunch and catering shops, feeding centers, etc. The frozen vegetable or frozen food of the present invention may be eaten directly after thawing or may be heat-treated before eating. Examples of the heat treatment include sautéing, baking, frying, and microwave treatment (by means of a microwave oven).

### EXAMPLES

The present invention will hereinafter be described based on examples. The present invention is not limited to the examples given below.

### Example 1. Preparation, Physical Properties, and Sensory Evaluation of Frozen Bell Pepper

### (1) Preparation of Frozen Bell Pepper

### (i) Preparation of Oven-Heated Product

Bell pepper with an average pericarp thickness of 2 mm was cut into 20×30 mm rectangular pieces, which were washed and drained. The drained rectangular pieces of bell pepper were arranged on a mesh, and the mesh was placed in a convection oven (FSCCWE61, manufactured by Fujimak Corporation), by which the rectangular pieces of bell pepper were oven-heated at a given temperature for a given period of time. The heated rectangular pieces of bell pepper were then collected and left to cool. After that, the rectangular pieces of bell pepper were arranged on a freezing plate and quickly frozen in a freezing chamber set at about −35° C. (test batches 1 to 5 in Table 1 shown in “(4) Result” below).

### (ii) Preparation of Non-Oven-Treated Product

Bell pepper with an average pericarp thickness of 2 mm was cut into 20×30 mm rectangular pieces, which were washed and drained. The drained rectangular pieces of bell pepper were arranged on a freezing plate and quickly frozen in a freezing chamber set at about −35° C. (test batch 6 in Table 1 shown in “(4) Result” below).

(iii) Preparation of Conventional Boiled Product

Bell pepper with an average pericarp thickness of 2 mm was cut into 20×30 mm rectangular pieces, which were washed and drained. The drained rectangular pieces of bell pepper were placed in hot water boiling at 100° C. and boiled for a given period of time. The boiled rectangular pieces of bell pepper were then collected, cooled with water, and drained. After that, the rectangular pieces of bell pepper were arranged on a freezing plate and quickly frozen in a freezing chamber set at about −35° C. (test batch 7 in Table 1 shown in “(4) Result” below).

### (iv) Preparation of Low-Temperature-Boiled Product

Bell pepper with an average pericarp thickness of 2 mm was cut into 20×30 mm rectangular pieces, which were washed and drained. The drained rectangular pieces of bell pepper were put into hot water at 60° C., and the rectangular pieces of bell pepper in hot water were placed in a convection oven maintained at 60° C. and were kept immersed in hot water for 10 minutes. The hot water-immersed rectangular pieces of bell pepper were then collected, cooled with water, and drained. After that, the rectangular pieces of bell pepper were arranged on a freezing plate and quickly frozen in a freezing chamber set at about −35° C. (test batch 8 in Table 1 shown in “(4) Result” below).

### (2) Physical Properties of Frozen Bell Pepper

The oven-heated products, non-oven-treated product, conventional boiled product, and low-temperature-boiled product of frozen bell pepper which were obtained in (1) were evaluated for their physical properties.

### (i) Measurement of Weight of Drip and Calculation of Drip Loss During Natural Thawing

For the frozen bell pepper in each test batch, the weight of frozen product (g) and the weight of drip during natural thawing (g) were measured according to the measurement methods specified in the detailed description of the invention in the present specification. For the frozen bell pepper in each test batch, the drip loss during natural thawing was calculated according to the definition given in the detailed description of the invention in the present specification.

### (ii) Measurement of Bulk Density and Calculation of Change in Bulk Density Relative to Fresh Product

For the frozen bell pepper in each test batch, the bulk density exclusive of drip after natural thawing (g/ml) and the bulk density of fresh bell pepper (g/ml) were measured according to the measurement methods specified in the detailed description of the invention in the present specification. Further, for the frozen bell pepper in each test batch, the change in bulk density relative to fresh product was calculated according to the definition given in the detailed description of the invention in the present specification.

### (3) Sensory Evaluation of Frozen Bell Pepper

The oven-heated products, non-oven-treated product, conventional boiled product, and low-temperature-boiled product of frozen bell pepper which were obtained in (1) were sautéed and subjected to sensory evaluation.

### (i) Method of Sautéing

A fry pan was heated until smoke was emitted, and 8 g of canola oil was then poured into the fry pan. Into this fry pan were introduced 200 g of the frozen bell pepper sample in each test batch and 1 g of common salt, and the bell pepper was sautéed over medium to high heat for 2.5 minutes.

### (ii) Method of Sensory Evaluation

After being sautéed by the method described in (i), the frozen bell pepper in each test batch was subjected to sensory evaluation made by five expert panelists. The following describes the evaluation items and evaluation criteria.

### (Evaluation of Appearance)

(a) Voluminosity

Possessed: +, Lacked: −

(b) Cookedness (the term “cookedness” as used herein refers to the property of giving the impression of being well-cooked, in particular well-sautéed, and having a burnt portion preferred in a sautéed food.)

Excellent appearance having cookedness: 4 points, Good appearance having cookedness: 3 points, Somewhat poor appearance giving the impression of being raw and lacking cookedness: 2 points, Poor appearance giving the impression of being raw and lacking cookedness: 1 point

### (Evaluation of Eating Quality)

(c) Cookedness (the term “cookedness” as used herein refers to the property of giving the impression of being well-cooked, in particular well-sautéed, and having a burnt portion preferred in a sautéed food.)

Excellent texture having cookedness: 4 points, Good texture having cookedness: 3 points, Somewhat poor texture giving the impression of being raw and lacking cookedness: 2 points, Poor texture giving the impression of being raw and lacking cookedness: 1 point

(d) Crunchy texture (the term “crunchy texture” as used herein refers to the property of not being extremely soft and offering pleasing firmness upon biting.)

Excellent crunchy texture: 4 points, Good crunchy texture: 3 points, Somewhat poor texture lacking crunchiness: 2 points, Poor texture lacking crunchiness: 1 point

(e) Wateriness

Excellent texture free of wateriness: 4 points, Good texture free of wateriness: 3 points, Somewhat poor texture with wateriness: 2 points, Poor texture with wateriness: 1 point

### (Overall Rating)

The average of the scores of the sensory evaluations (b) to (e) is graded according to the following criteria to give an overall rating.

3.5 points or more: A

2.5 points or more: B

1.5 points or more: C

Less than 1.5 points: D

A score of 2.5 points or more was considered an acceptable level, while a score of less than 2.5 points was considered an unacceptable level.

### (4) Result

The physical properties and the sensory evaluation results of the frozen bell pepper in each test batch were as shown in Table 1 below,

TABLE 1
Physical Properties and Sensory Evaluation of Frozen Bell Pepper

| | | | | | | Sensory evaluation | | | | | | |
|---|---|---|---|---|---|---|---|---|---|---|---|---|
| | | | | Physical properties | | | | | | | | |
| | | | | Drip loss | Change in | | | Appearance | | Eating quality | | |
| | Heat treatment | | | during | bulk density | Overall quality | | Volumi- | | | Crunch- | |
| Test | | Temperature | Time | natural | relative to | Overall | Average | nosity | Cookedness | Cookedness | iness | Wateriness |
| batch | Method | (° C.) | (min) | thawing (%) | fresh product | rating | score | (+/−) | (1 to 4) | (1 to 4) | (1 to 4) | (1 to 4) |
| 1 | Oven | 40 | 90 | 0.10 | 1.52 | B | 3.1 | + | 3.6 | 2.4 | 3.8 | 2.6 |
| 2 | Oven | 50 | 40 | 0.50 | 1.63 | B | 3.1 | + | 3.2 | 2.4 | 3.6 | 3.2 |
| 3 | Oven | 60 | 20 | 0.80 | 1.62 | A | 3.5 | + | 4.0 | 3.8 | 2.8 | 3.4 |
| 4 | Oven | 70 | 12 | 1.20 | 1.67 | B | 3.2 | + | 3.4 | 3.4 | 2.8 | 3.0 |
| 5 | Oven | 100 | 7 | 4.80 | 2.00 | C | 2.0 | − | 2.2 | 2.4 | 1.6 | 1.8 |
| 6 | — | — | — | 8.00 | 1.58 | C | 2.4 | − | 2.2 | 1.4 | 3.0 | 2.8 |
| 7 | Boiling | 100 | 2.5 | 13.10 | 1.65 | D | 1.2 | − | 1.2 | 1.4 | 1.0 | 1.0 |
| 8 | Boiling | 60 | 10 | 13.00 | 2.14 | D | 1.4 | − | 1.8 | 1.4 | 1.2 | 1.2 |

Frozen bell pepper prepared by subjecting bell pepper to oven heat treatment at 40 to 70° C. for 12 to 90 minutes and subsequently freezing the treated bell pepper exhibited physical properties with a drip loss during natural thawing of 0.10 to 1.20% and a change in bulk density relative to fresh product of 1.52 to 1.67. The frozen bell pepper was given an overall rating of “A” or “B” in the sensory evaluation (test batches 1 to 4). Frozen bell pepper prepared through oven heat treatment at 100° C. prior to freezing exhibited physical properties with a change in bulk density relative to fresh product of as large as 2.00. In the sensory evaluation, the frozen bell pepper was evaluated as lacking voluminosity and being inferior in terms of crunchiness and wateriness and was given an overall rating of “C” (test batch 5). Frozen bell pepper prepared without any heat treatment prior to freezing exhibited physical properties with a drip loss during natural thawing of as high as 8.00%. In the sensory evaluation, the frozen bell pepper was evaluated as lacking voluminosity and cookedness and was given an overall rating of “C” (test batch 6). Frozen bell pepper prepared through treatment according to conventional art (boiling or low-temperature boiling prior to freezing) exhibited physical properties with a drip loss during natural thawing of as high as 13.00 to 13.10%. In the sensory evaluation, the frozen bell pepper was evaluated as lacking voluminosity and cookedness and being inferior in terms of crunchiness and wateriness and was given an overall rating of “D” (test batches 7 and 8).

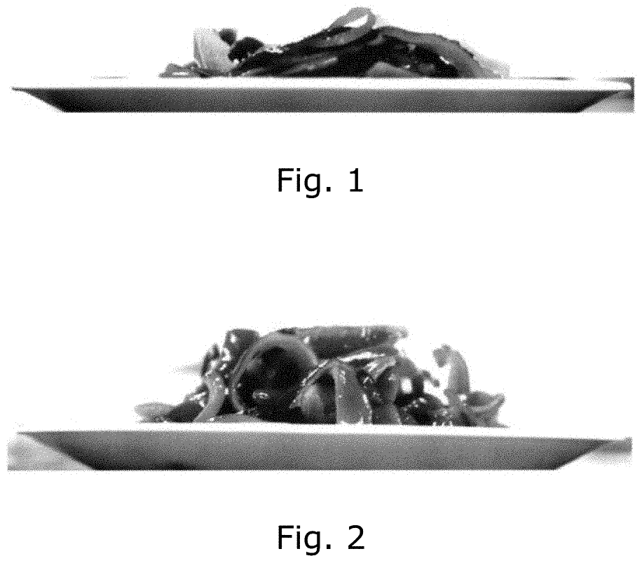

Frozen bell pepper was prepared using the same conditions as in test batch 7, except that bell pepper with an average pericarp thickness of 2 mm was vertically cut into halves, the halves were cut into 10-mm-wide strips, and the strips were washed and drained. A cooked product resulting from sautéing of this frozen bell pepper presented a small volume and lacked voluminosity (FIG. 1). Further, frozen bell pepper was prepared using the same conditions as in test batch 4, except that bell pepper with an average pericarp thickness of 2 mm was vertically cut into halves, the halves were cut into 10-mm-wide strips, and the strips were washed and drained. A cooked product resulting from sautéing of this frozen bell pepper presented a large volume and had voluminosity (FIG. 2).

### Example 2. Preparation, Physical Properties, and Sensory Evaluation of Frozen Onion

### (1) Preparation of Frozen Onion

### (i) Preparation of Oven-Heated Product Etc.

Oven-heated products (test batches 9 to 13 in Table 2 shown in “(4) Result” below), a non-oven-treated product (test batch 14 in Table 2 shown in “(4) Result” below), a conventional boiled product (test batch 15 In Table 2 shown in “(4) Result” below), and a low-temperature-boiled product (test batch 16 in Table 2 shown in “(4) Result” below) of frozen onion were prepared according to methods as described in (1) of Example 1, except that ⅛ wedge of onion with a standardized size of “L” or “2L” was cut into halves, which were used as a starting material.

### (2) Physical Properties of Frozen Onion

The oven-heated products, non-oven-treated product, conventional boiled product, and low-temperature-boiled product of frozen onion which were obtained in (1) were evaluated for their physical properties. The measurement of the weight of frozen product (g) and the weight of drip during natural thawing (g) of the frozen onion in each test batch, the calculation of the drip loss during natural thawing of the frozen onion in each test batch, the measurement of the bulk density exclusive of drip after natural thawing (g/ml) of the frozen onion in each test batch and the bulk density of fresh onion (g/ml), and the calculation of the change in bulk density relative to fresh product, of the frozen onion in each test batch were carried out according to the methods specified in the detailed description of the invention in the present specification.

### (3) Sensory Evaluation of Frozen Onion

The oven-heated products, non-oven-treated product, conventional boiled product, and low-temperature-boiled product of frozen onion which were obtained in (1) were sautéed and subjected to sensory evaluation. The sautéing and sensory evaluation were carried out according to methods as described in (3)(i) and (3)(ii) of Example 1, except that the sensory evaluation was made by seven expert panelists.

### (4) Result

The physical properties and the sensory evaluation results of the frozen onion in each test batch were as shown in Table 2 below.

TABLE 2

| | | | | | | Sensory evaluation | | | | | | |
|---|---|---|---|---|---|---|---|---|---|---|---|---|
| | | | | Physical properties | | | | | | | | |
| | | | | Drip loss | Change in | | | Appearance | | Eating quality | | |
| | Heat treatment | | | during | bulk density | Overall quality | | Volumi- | | | Crunch- | |
| Test | | Temperature | Time | natural | relative to | Overall | Average | nosity | Cookedness | Cookedness | iness | Wateriness |
| batch | Method | (° C.) | (min) | thawing (%) | fresh product | rating | score | (+/−) | (1 to 4) | (1 to 4) | (1 to 4) | (1 to 4) |
| 9 | Oven | 40 | 120 | 10.38 | 1.77 | C | 1.9 | − | 1.9 | 2.3 | 1.6 | 1.7 |
| 10 | Oven | 50 | 60 | 7.25 | 1.79 | C | 2.2 | − | 2.3 | 2.4 | 2.0 | 2.0 |
| 11 | Oven | 60 | 30 | 1.64 | 1.72 | A | 4.0 | + | 4.0 | 4.0 | 4.0 | 4.0 |
| 12 | Oven | 75 | 14 | 3.79 | 1.73 | B | 3.1 | + | 3.1 | 3.1 | 3.2 | 3.1 |
| 13 | Oven | 100 | 9 | 2.49 | 1.94 | C | 1.7 | − | 2.1 | 1.7 | 1.6 | 1.3 |
| 14 | — | — | — | 17.11 | 1.85 | C | 1.5 | − | 1.1 | 1.9 | 1.3 | 1.6 |
| 15 | Boiling | 100 | 2 | 16.71 | 2.04 | C | 1.6 | − | 1.1 | 2.1 | 1.7 | 1.3 |
| 16 | Boiling | 60 | 10 | 15.86 | 1.89 | C | 1.5 | − | 1.1 | 1.4 | 2.0 | 1.4 |

Frozen onion prepared by subjecting onion to oven heat treatment at 60 to 75° C. for 14 to 30 minutes and subsequently freezing the treated onion exhibited physical properties with a drip loss during natural thawing of 1.64 to 3.79% and a change in bulk density relative to fresh product of 1.72 to 1.73. The frozen onion was given an overall rating of “A” or “B” in the sensory evaluation (test batches 11 and 12). Frozen onion prepared through oven heat treatment at 40 to 50° C. prior to freezing exhibited physical properties with a drip loss during natural thawing of as high as 7.25 to 10.38%. In the sensory evaluation, the frozen onion was evaluated as lacking voluminosity and being inferior in terms of crunchiness and wateriness and was given an overall rating of “C” (test batches 9 and 10). Frozen onion prepared through oven heat treatment at 100° C. prior to freezing exhibited physical properties with a change in bulk density relative to fresh product of as large as 1.94. In the sensory evaluation, the frozen onion was evaluated as lacking voluminosity and being inferior in terms of cookedness, crunchiness, and wateriness and was given an overall rating of “C” (test batch 13). Frozen onion prepared without any heat treatment prior to freezing exhibited physical properties with a drip loss during natural thawing of as high as 17.11%. In the sensory evaluation, the frozen onion was evaluated as lacking voluminosity and cookedness and being inferior in terms of crunchiness and wateriness and was given an overall rating of “C” (test batch 14). Frozen onion prepared through treatment according to conventional art (boiling or low-temperature boiling prior to freezing) exhibited physical properties with a drip loss during natural thawing of as high as 15.86 to 16.71%. In the sensory evaluation, the frozen onion was evaluated as lacking voluminosity and cookedness and being inferior in terms of crunchiness and wateriness and was given an overall rating of “C” (test batches 15 and 16).

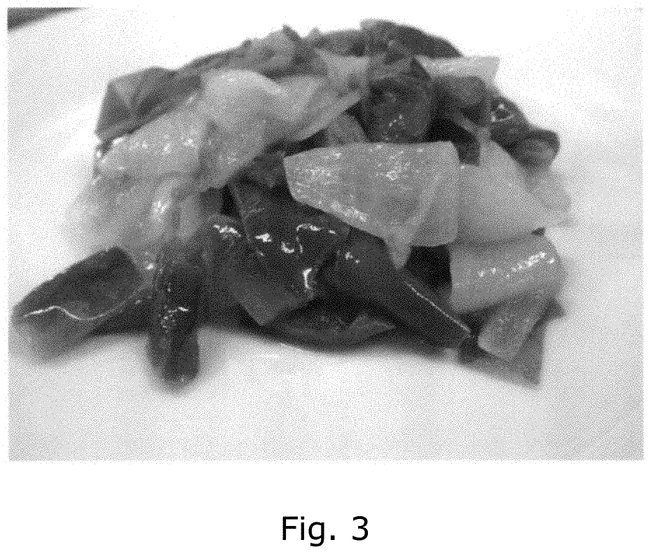

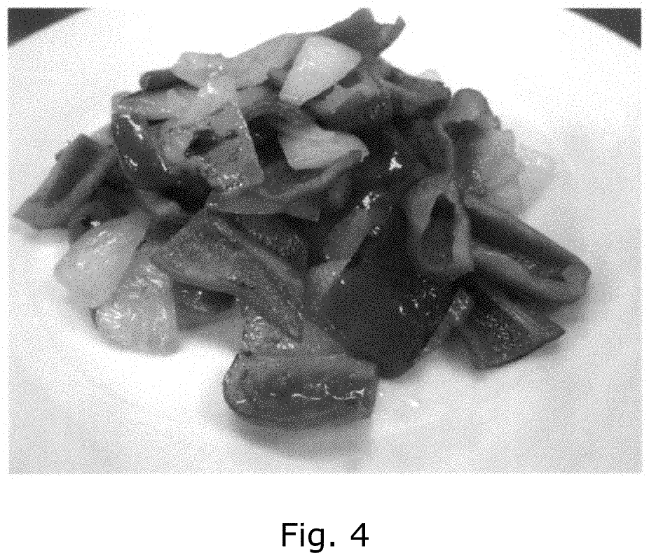

A cooked product resulting from sautéing of frozen bell pepper prepared using the conditions of test batch 7 and frozen onion prepared using the conditions of test batch 15 had poor shape retention and lacked voluminosity (FIG. 3). On the other hand, a cooked product resulting from sautéing of frozen bell pepper prepared using the conditions of test batch 3 and frozen onion prepared using the conditions of test batch 11 had good shape retention and voluminosity (FIG. 4). A burnt portion was also observed (FIG. 4).

### Example 3. Preparation, Physical Properties, and Sensory Evaluation of Frozen Carrot

### (1) Preparation of Frozen Carrot

### (i) Preparation of Oven-Heated Product Etc.

Oven-heated products (test batches 17 and 18 in Table 3 shown in “(4) Result” below) and a conventional boiled product (test batch 19 in Table 3 shown in “(4) Result” below) of frozen carrot were prepared according to methods as described in (1) of Example 1, except that carrot with a standardized size of “2L” (average weight: 375 g) was cut into 3×3×50 mm sticks, which were used as a starting material.

### (2) Physical Properties of Frozen Carrot

The oven-heated products and conventional boiled product of frozen carrot which were obtained in (1) were evaluated for their physical properties. The measurement of the weight of frozen product (g) and the weight of drip during natural thawing (g) of the frozen carrot in each test batch, the calculation of the drip loss during natural thawing of the frozen carrot in each test batch, the measurement of the bulk density exclusive of drip after natural thawing (g/ml) of the frozen carrot in each test batch and the bulk density of fresh carrot (g/ml), and the calculation of the change in bulk density relative to fresh product, of the frozen carrot in each test batch were carried out according to the methods specified in the detailed description of the invention in the present specification.

### (3) Sensory Evaluation of Frozen Carrot

The oven-heated products and conventional boiled product of frozen carrot which were obtained in (1) were sautéed and subjected to sensory evaluation. The sautéing and sensory evaluation were carried out according to methods as described in (3)(i) and (3)(ii) of Example 1.

### (4) Result

The physical properties and the sensory evaluation results of the frozen carrot in each test batch were as shown in Table 3 below.

TABLE 3
Physical Properties and Sensory Evaluation of Frozen Carrot

| | | | | | | Sensory evaluation | | | | | | |
|---|---|---|---|---|---|---|---|---|---|---|---|---|
| | | | | Physical properties | | | | | | | | |
| | | | | Drip loss | Change in | | | Appearance | | Eating quality | | |
| | Heat treatment | | | during | bulk density | Overall quality | | Volumi- | | | Crunch- | |
| Test | | Temperature | Time | natural | relative to | Overall | Average | nosity | Cookedness | Cookedness | iness | Wateriness |
| batch | Method | (° C.) | (min) | thawing (%) | fresh product | rating | score | (+/−) | (1 to 4) | (1 to 4) | (1 to 4) | (1 to 4) |
| 17 | Oven | 60 | 14 | 0.43 | 1.71 | A | 3.6 | + | 3.6 | 3.4 | 3.6 | 3.6 |
| 18 | Oven | 100 | 4 | 2.16 | 1.91 | C | 2.4 | − | 3.0 | 1.7 | 2.5 | 2.5 |
| 19 | Boiling | 100 | 2.5 | 7.34 | 1.91 | D | 1.6 | − | 2.4 | 1.9 | 1.0 | 1.2 |

Frozen carrot prepared by subjecting carrot to oven heat treatment at 60° C. for 14 minutes and subsequently freezing the treated carrot exhibited physical properties with a drip loss during natural thawing of 0.43% and a change in bulk density relative to fresh product of 1.71. The frozen carrot was given an overall rating of “A” in the sensory evaluation (test batch 17). Frozen carrot prepared through oven heat treatment at 100° C. prior to freezing exhibited physical properties with a change in bulk density relative to fresh product of as large as 1.91. In the sensory evaluation, the frozen carrot was evaluated as lacking voluminosity. Further, the frozen carrot was evaluated as lacking cookedness in the eating quality evaluation, albeit being evaluated as having cookedness in the appearance evaluation. The frozen carrot was also evaluated as being somewhat inferior in terms of crunchiness and wateriness and was given an overall rating of “C” (test batch 18). Frozen carrot prepared through treatment according to conventional art (boiling prior to freezing) exhibited physical properties with a drip loss during natural thawing of as high as 7.34% and a change in bulk density relative to fresh product of as large as 1.91. In the sensory evaluation, the frozen carrot was evaluated as lacking voluminosity and cookedness and being inferior in terms of crunchiness and wateriness and was given an overall rating of “D” (test batch 19).

### Example 4. Preparation, Physical Properties, and Sensory Evaluation of Frozen Cabbage

### (1) Preparation of Frozen Cabbage

### (i) Preparation of Oven-Heated Product Etc.

Oven-heated products (test batches 20 and 21 in Table 4 shown in “(4) Result” below) and a conventional boiled product (test batch 22 in Table 4 shown in “(4) Result” below) of frozen cabbage were prepared according to methods as described in (1) of Example 1, except that cabbage with a standardized size of “L” (average weight: 1350 g) was cut into 30×30 mm rectangular pieces, which were used as a starting material.

### (2) Physical Properties of Frozen Cabbage

The oven-heated products and conventional boiled product of frozen cabbage which were obtained in (1) were evaluated for their physical properties. The measurement of the weight of frozen product (g) and the weight of drip during natural thawing (g) of the frozen cabbage in each test batch, the calculation of the drip loss during natural thawing of the frozen cabbage in each test batch, the measurement of the bulk density exclusive of drip after natural thawing (g/ml) of the frozen cabbage in each test batch and the bulk density of fresh cabbage (g/ml), and the calculation of the change in bulk density relative to fresh product, of the frozen cabbage in each test batch were carried out according to the methods specified in the detailed description of the invention in the present specification.

### (3) Sensory Evaluation of Frozen Cabbage

The oven-heated products and conventional boiled product of frozen cabbage which were obtained in (1) were sautéed and subjected to sensory evaluation. The sautéing and sensory evaluation were carried out according to methods as described in (3)(i) and (3)(ii) of Example 1.

### (4) Result

The physical properties and the sensory evaluation results of the frozen cabbage in each test batch were as shown in Table 4 below.

TABLE 4
Physical Properties and Sensory Evaluation of Frozen Cabbage

| | | | | | | Sensory evaluation | | | | | | |
|---|---|---|---|---|---|---|---|---|---|---|---|---|
| | | | | Physical properties | | | | | | | | |
| | | | | Drip loss | Change in | | | Appearance | | Eating quality | | |
| | Heat treatment | | | during | bulk density | Overall quality | | Volumi- | | | Crunch- | |
| Test | | Temperature | Time | natural | relative to | Overall | Average | nosity | Cookedness | Cookedness | iness | Wateriness |
| batch | Method | (° C.) | (min) | thawing (%) | fresh product | rating | score | (+/−) | (1 to 4) | (1 to 4) | (1 to 4) | (1 to 4) |
| 20 | Oven | 60 | 11 | 0.30 | 1.78 | A | 4.0 | + | 4.0 | 4.0 | 4.0 | 4.0 |
| 21 | Oven | 100 | 3 | 0.47 | 2.16 | C | 2.3 | − | 2.4 | 2.7 | 2.0 | 2.1 |
| 22 | Boiling | 100 | 2.5 | 6.21 | 3.56 | D | 1.1 | − | 1.0 | 1.0 | 1.2 | 1.0 |

Frozen cabbage prepared by subjecting cabbage to oven heat treatment at 60° C. for 11 minutes and subsequently freezing the treated cabbage exhibited physical properties with a drip loss during natural thawing of 0.30% and a change in bulk density relative to fresh product of 1.78. The frozen cabbage was given an overall rating of “A” in the sensory evaluation (test batch 20). Frozen cabbage prepared through oven heat treatment at 100° C. prior to freezing exhibited physical properties with a change in bulk density relative to fresh product of as large as 2.16. In the sensory evaluation, the frozen cabbage was evaluated as lacking voluminosity. Further, the frozen cabbage was evaluated as lacking cookedness in the appearance evaluation, albeit being evaluated as having slight degree of cookedness in the eating quality evaluation. The frozen cabbage was also evaluated as being inferior in terms of crunchiness and wateriness and was given an overall rating of “C” (test batch 21). Frozen cabbage prepared through treatment according to conventional art (boiling prior to freezing) exhibited physical properties with a drip loss during natural thawing of as high as 6.21% and a change in bulk density relative to fresh product of as large as 3.56. In the sensory evaluation, the frozen cabbage was evaluated as lacking voluminosity and cookedness and being inferior in terms of crunchiness and wateriness and was given an overall rating of “D” (test batch 22).

The physical properties and the sensory evaluation results in Examples 1 to 4 lead to the conclusion that a frozen vegetable exhibiting a drip loss during natural thawing of 7.20% or less and exhibiting a change in bulk density relative to fresh product of 1.90 or less will be considered to have voluminosity, cookedness, and crunchiness and be free of wateriness. It is also concluded that dry heat treatment at 40 to 75° C. for 5 to 300 minutes prior to freezing is effective to obtain such a frozen vegetable.

### Example 5. Preparation, Physical Properties, and Sensory Evaluation of Frozen Bell Pepper (Part 2: Evaluation of Influence of Method of Dry Heat Treatment)

### (1) Preparation of Frozen Bell Pepper

### (i) Preparation of Oven-Heated Product Etc.

A jet oven-heated product (test batch 23 in Table 5 shown in “(4) Result” below) of frozen bell pepper was prepared according to a method as described in (1) of Example 1, except that a jet oven (PS220R68, manufactured by Middleby Marshall) was used as means for dry heat treatment.

### (2) Physical Properties of Frozen Bell Pepper

The jet oven-heated product of frozen bell pepper which was obtained in (1) was evaluated for its physical properties. The measurement of the weight of frozen product (g) and the weight of drip during natural thawing (g) of the frozen bell pepper in test batch 23, the calculation of the drip loss during natural thawing of the frozen bell pepper in test batch 23, the measurement of the bulk density exclusive of drip after natural thawing (g/ml) of the frozen bell pepper in test batch 23 and the bulk density of fresh bell pepper (g/ml), and the calculation of the change in bulk density relative to fresh product, of the frozen bell pepper in test batch 23 were carried out according to the methods specified in the detailed description of the invention in the present specification.

### (3) Sensory Evaluation of Frozen Bell Pepper

The jet oven-heated product of frozen bell pepper which was obtained in (1) was sautéed and subjected to sensory evaluation. The sautéing and sensory evaluation were carried out according to methods as described in (3)(i) and (3)(ii) of Example 1.

### (4) Result

The physical properties and the sensory evaluation results of the frozen bell pepper in test batch 23 were as shown in Table 5 below.

TABLE 5
Physical Properties and Sensory Evaluation of Frozen Bell Pepper

| | | | | | | Sensory evaluation | | |
|---|---|---|---|---|---|---|---|---|
| | | | | Physical properties | | | | |
| | | | | | Change in | | | Appearance |
| | Heat treatment | | | Drip loss | bulk density | Overall quality | | Volumi- |
| Test | | Temperature | Time | during natural | relative to | Overall | Average | nosity |
| batch | Method | (° C.) | (min) | thawing (%) | fresh product | rating | score | (+/−) |
| 23 | Jet oven | 130 | 1.5 | 1.90 | 1.44 | A | 3.8 | + |

Frozen bell pepper prepared by subjecting bell pepper to jet oven heat treatment at 130° C. for 1.5 minutes and subsequently freezing the treated bell pepper exhibited physical properties with a drip loss during natural thawing of 1.90% and a change in bulk density relative to fresh product of 1.44. The frozen bell pepper was given an overall rating of “A” in the sensory evaluation (test batch 23).

The result of test batch 23 revealed that frozen bell pepper of the present invention can be prepared even through dry heat treatment performed by means of a jet oven at a high temperature for a short time (at 130° C. for 1.5 minutes).

### Example 6. Preparation, Physical Properties, and Sensory Evaluation of Frozen Onion (Part 2: Evaluation of Influence of Method of Dry Heat Treatment)

### (1) Preparation of Frozen Onion

### (i) Preparation of Oven-Heated Product Etc.

A jet oven-heated product (test batch 24 in Table 6 shown in “(4) Result” below) of frozen onion was prepared according to a method as described in (1) of Example 1, except that a jet oven (PS220R68, manufactured by Middleby Marshall) was used as means for dry heat treatment.

### (2) Physical Properties of Frozen Onion

The jet oven-heated product of frozen onion which was obtained in (1) was evaluated for its physical properties. The measurement of the weight of frozen product (g) and the weight of drip during natural thawing (g) of the frozen onion in test batch 24, the calculation of the drip loss during natural thawing of the frozen onion in test batch 24, the measurement of the bulk density exclusive of drip after natural thawing (g/ml) of the frozen onion in test batch 24 and the bulk density of fresh onion (g/ml), and the calculation of the change in bulk density relative to fresh product, of the frozen onion in test batch 24 were carried out according to the methods specified in the detailed description of the invention in the present specification.

### (3) Sensory Evaluation of Frozen Onion

The jet oven-heated product of frozen onion which was obtained in (1) was sautéed and subjected to sensory evaluation. The sautéing and sensory evaluation were carried out according to methods as described in (3)(i) and (3)(ii) of Example 1.

### (4) Result

The physical properties and the sensory evaluation results of the frozen onion in test batch 24 were as shown in Table 6 below.

TABLE 6
Physical Properties and Sensory Evaluation of Frozen Onion

| | | | | | | Sensory evaluation | | |
|---|---|---|---|---|---|---|---|---|
| | | | | Physical properties | | | | |
| | | | | | Change in | | | Appearance |
| | Heat treatment | | | Drip loss | bulk density | Overall quality | | Volumi- |
| Test | | Temperature | Time | during natural | relative to | Overall | Average | nosity |
| batch | Method | (° C.) | (min) | thawing (%) | fresh product | rating | score | (+/−) |
| 24 | Jet oven | 120 | 2.5 | 0.25 | 1.64 | A | 3.8 | + |

Frozen onion prepared by subjecting onion to jet oven heat treatment at 120° C. for 2.5 minutes and subsequently freezing the treated onion exhibited physical properties with a drip loss during natural thawing of 0.25% and a change in bulk density relative to fresh product of 1.64. The frozen onion was given an overall rating of “A” in the sensory evaluation (test batch 24).

The result of test batch 24 revealed that frozen onion of the present invention can be prepared even through dry heat treatment performed by means of a jet oven at a high temperature for a short time (at 120° C. for 2.5 minutes).

### Example 7. Preparation, Physical Properties, and Sensory Evaluation of Frozen Red Paprika

### (1) Preparation of Frozen Red Paprika

### (i) Preparation of Oven-Heated Product Etc.

An oven-heated product (test batch 25 in Table 7 shown in “(4) Result” below) and a conventional boiled product (test batch 26 in Table 7 shown in “(4) Result” below) of frozen red paprika were prepared according to methods as described in (1) of Example 1, except that red paprika with an average pericarp thickness of about 6 mm was cut into 20×30 mm rectangular pieces, which were used as a starting material.

### (2) Physical Properties of Frozen Red Paprika

The oven-heated product and conventional boiled product of frozen red paprika which were obtained in (1) were evaluated for their physical properties. The measurement of the weight of frozen product (g) and the weight of drip during natural thawing (g) of the frozen red paprika in each test batch, the calculation of the drip loss during natural thawing of the frozen red paprika in each test batch, the measurement of the bulk density exclusive of drip after natural thawing (g/ml) of the frozen red paprika in each test batch and the bulk density of fresh red paprika (g/ml), and the calculation of the change in bulk density relative to fresh product, of the frozen red paprika in each test batch were carried out according to the methods specified in the detailed description of the invention in the present specification.

### (3) Sensory Evaluation of Frozen Red Paprika

The oven-heated product and conventional boiled product of frozen red paprika which were obtained in (1) were sautéed and subjected to sensory evaluation. The sautéing and sensory evaluation were carried out according to methods as described in (3)(i) and (3)(ii) of Example 1.

### (4) Result

The physical properties and the sensory evaluation results of the frozen red paprika in each test batch were as shown in Table 7 below.

TABLE 7
Physical Properties and Sensory Evaluation of Frozen Red Paprika

| | | | | | | Sensory evaluation | | |
|---|---|---|---|---|---|---|---|---|
| | | | | Physical properties | | | | |
| | | | | | Change in | | | Appearance |
| | Heat treatment | | | Drip loss | bulk density | Overall quality | | Volumi- |
| Test | | Temperature | Time | during natural | relative to | Overall | Average | nosity |
| batch | Method | (° C.) | (min) | thawing (%) | fresh product | rating | score | (+/−) |
| 25 | Oven | 40 | 120 | 3.79 | 1.26 | A | 3.8 | + |
| 26 | Boiling | 100 | 2.5 | 22.11 | 1.68 | D | 1.4 | − |

Frozen red paprika prepared by subjecting red paprika to oven heat treatment at 40° C. for 120 minutes and subsequently freezing the treated red paprika exhibited physical properties with a drip loss during natural thawing of 3.79% and a change in bulk density relative to fresh product of 1.26. The frozen red paprika was given an overall rating of “A” in the sensory evaluation (test batch 25). Frozen red paprika prepared through treatment according to conventional art (boiling prior to freezing) exhibited physical properties with a drip loss during natural thawing of as high as 22.11%. In the sensory evaluation, the frozen red paprika was evaluated as lacking voluminosity and was given an overall rating of “D” (test batch 26).

The result of test batch 25 revealed that frozen red paprika of the present invention can be prepared through dry heat treatment performed by means of an oven at 40° C. for 120 minutes.

### Example 8. Preparation, Physical Properties, and Sensory Evaluation of Frozen Yellow Paprika

### (1) Preparation of Frozen Yellow Paprika

### (i) Preparation of Oven-Heated Product Etc.

An oven-heated product (test batch 27 in Table 8 shown in “(4) Result” below) and a conventional boiled product (test batch 28 in Table 8 shown in “(4) Result” below) of frozen yellow paprika were prepared according to methods as described in (1) of Example 1, except that yellow paprika with an average pericarp thickness of about 6 mm was cut into 20×30 mm rectangular pieces, which were used as a starting material.

### (2) Physical Properties of Frozen Yellow Paprika

The oven-heated product and conventional boiled product of frozen yellow paprika which were obtained in (1) were evaluated for their physical properties. The measurement of the weight of frozen product (g) and the weight of drip during natural thawing (g) of the frozen yellow paprika in each test batch, the calculation of the drip loss during natural thawing of the frozen yellow paprika in each test batch, the measurement of the bulk density exclusive of drip after natural thawing (g/ml) of the frozen yellow paprika in each test batch and the bulk density of fresh yellow paprika (g/ml), and the calculation of the change in bulk density relative to fresh product, of the frozen yellow paprika in each test batch were carried out according to the methods specified in the detailed description of the invention in the present specification.

### (3) Sensory Evaluation of Frozen Yellow Paprika

The oven-heated product and conventional boiled product of frozen yellow paprika which were obtained in (1) were sautéed and subjected to sensory evaluation. The sautéing and sensory evaluation were carried out according to methods as described in (3)(i) and (3)(ii) of Example 1.

### (4) Result

The physical properties and the sensory evaluation results of the frozen yellow paprika in each test batch were as shown in Table 8 below.

TABLE 8
Physical Properties and Sensory Evaluation of Frozen Yellow Paprika

| | | | | | | Sensory evaluation | | |
|---|---|---|---|---|---|---|---|---|
| | | | | Physical properties | | | | |
| | | | | | Change in | | | Appearance |
| | Heat treatment | | | Drip loss | bulk density | Overall quality | | Volumi- |
| Test | | Temperature | Time | during natural | relative to | Overall | Average | nosity |
| batch | Method | (° C.) | (min) | thawing (%) | fresh product | rating | score | (+/−) |
| 27 | Oven | 40 | 120 | 4.51 | 1.16 | A | 3.7 | + |
| 28 | Boiling | 100 | 2.5 | 27.02 | 1.67 | D | 1.4 | − |

Frozen yellow paprika prepared by subjecting yellow paprika to oven heat treatment at 40° C. for 120 minutes and subsequently freezing the treated yellow paprika exhibited physical properties with a drip loss during natural thawing of 4.51% and a change in bulk density relative to fresh product of 1.16. The frozen yellow paprika was given an overall rating of “A” in the sensory evaluation (test batch 27). Frozen yellow paprika prepared through treatment according to conventional art (boiling prior to freezing) exhibited physical properties with a drip loss during natural thawing of as high as 27.02%. In the sensory evaluation, the frozen yellow paprika was evaluated as lacking voluminosity and was given an overall rating of “D” (test batch 28).

The result of test batch 27 revealed that frozen yellow paprika of the present invention can be prepared through dry heat treatment performed by means of an oven at 40° C. for 120 minutes.

### Example 9. Preparation, Physical Properties, and Sensory Evaluation of Frozen Zucchini

### (1) Preparation of Frozen Zucchini

### (i) Preparation of Oven-Heated Product Etc.

Oven-heated products (test batches 29 and 30 in Table 9 shown in “(4) Result” below) and a conventional boiled product (test batch 31 in Table 9 shown in “(4) Result” below) of frozen zucchini were prepared according to methods as described in (1) of Example 1, except that zucchini with a diameter of about 3 cm was cut into halves, and the halves were cut into 5-mm-thick slices, which were used as a starting material.

### (2) Physical Properties of Frozen Zucchini

The oven-heated products and conventional boiled product of frozen zucchini which were obtained in (1) were evaluated for their physical properties. The measurement of the weight of frozen product (g) and the weight of drip during natural thawing (g) of the frozen zucchini in each test batch, the calculation of the drip loss during natural thawing of the frozen zucchini in each test batch, the measurement of the bulk density exclusive of drip after natural thawing (g/ml) of the frozen zucchini in each test batch and the bulk density of fresh zucchini (g/ml), and the calculation of the change in bulk density relative to fresh product, of the frozen zucchini in each test batch were carried out according to the methods specified in the detailed description of the invention in the present specification.

### (3) Sensory Evaluation of Frozen Zucchini

The oven-heated products and conventional boiled product of frozen zucchini which were obtained in (1) were sautéed and subjected to sensory evaluation. The sautéing and sensory evaluation were carried out according to methods as described in (3)(i) and (3)(ii) of Example 1.

### (4) Result

The physical properties and the sensory evaluation results of the frozen zucchini in each test batch were as shown in Table 9 below.

TABLE 9
Physical Properties and Sensory Evaluation of Frozen Zucchini

| | | | | | | Sensory evaluation | | |
|---|---|---|---|---|---|---|---|---|
| | | | | Physical properties | | | | |
| | | | | | Change in | | | Appearance |
| | Heat treatment | | | Drip loss | bulk density | Overall quality | | Volumi- |
| Test | | Temperature | Time | during natural | relative to | Overall | Average | nosity |
| batch | Method | (° C.) | (min) | thawing (%) | fresh product | rating | score | (+/−) |
| 29 | Oven | 60 | 30 | 1.22 | 1.48 | B | 3.4 | + |
| 30 | Oven | 100 | 10 | 0.41 | 1.56 | A | 4.0 | + |
| 31 | Boiling | 100 | 2.5 | 16.92 | 1.71 | D | 1.3 | − |

Frozen zucchini prepared by subjecting zucchini to oven heat treatment at 60° C. for 30 minutes and subsequently freezing the treated zucchini exhibited physical properties with a drip loss during natural thawing of 1.22% and a change in bulk density relative to fresh product of 1.48. The frozen zucchini was given an overall rating of “B” in the sensory evaluation (test batch 29). Frozen zucchini prepared by subjecting zucchini to oven heat treatment at 100° C. for 10 minutes and subsequently freezing the treated zucchini exhibited physical properties with a drip loss during natural thawing of 0.41% and a change in bulk density relative to fresh product of 1.56. The frozen zucchini was given an overall rating of “A” in the sensory evaluation (test batch 30). Frozen zucchini prepared through treatment according to conventional art (boiling prior to freezing) exhibited physical properties with a drip loss during natural thawing of as high as 16.92%. In the sensory evaluation, the frozen zucchini was evaluated as lacking voluminosity and was given an overall rating of “D” (test batch 31).

The results of test batches 29 and 30 revealed that frozen zucchini of the present invention can be prepared through dry heat treatment performed by means of an oven at 60 to 100° C. for 10 to 30 minutes.

### Example 10. Preparation, Physical Properties, and Sensory Evaluation of Frozen Bitter Gourd

### (1) Preparation of Frozen Bitter Gourd

### (i) Preparation of Oven-Heated Product Etc.

Oven-heated products (test batches 32 and 33 in Table 10 shown in “(4) Result” below) and a conventional boiled product (test batch 34 in Table 10 shown in “(4) Result” below) of frozen bitter gourd were prepared according to methods as described in (1) of Example 1, except that bitter gourd with a length of about 30 cm was cut into halves, and the halves were cut into 5-mm-thick slices, which were used as a starting material.

### (2) Physical Properties of Frozen Bitter Gourd

The oven-heated products and conventional boiled product of frozen bitter gourd which were obtained in (1) were evaluated for their physical properties. The measurement of the weight of frozen product (g) and the weight of drip during natural thawing (g) of the frozen bitter gourd in each test batch, the calculation of the drip loss during natural thawing of the frozen bitter gourd in each test batch, the measurement of the bulk density exclusive of drip after natural thawing (g/ml) of the frozen bitter gourd in each test batch and the bulk density of fresh bitter gourd (g/ml), and the calculation of the change in bulk density relative to fresh product, of the frozen bitter gourd in each test batch were carried out according to the methods specified in the detailed description of the invention in the present specification.

### (3) Sensory Evaluation of Frozen Bitter Gourd

The oven-heated products and conventional boiled product of frozen bitter gourd which were obtained in (1) were sautéed and subjected to sensory evaluation. The sautéing and sensory evaluation were carried out according to methods as described in (3)(i) and (3)(ii) of Example 1.

### (4) Result

The physical properties and the sensory evaluation results of the frozen bitter gourd in each test batch were as shown in Table 10 below.

TABLE 10
Physical Properties and Sensory Evaluation of Frozen Bitter Gourd

| | | | | | | Sensory evaluation | | |
|---|---|---|---|---|---|---|---|---|
| | | | | Physical properties | | | | |
| | | | | | Change in | | | Appearance |
| | Heat treatment | | | Drip loss | bulk density | Overall quality | | Volumi- |
| Test | | Temperature | Time | during natural | relative to | Overall | Average | nosity |
| batch | Method | (° C.) | (min) | thawing (%) | fresh product | rating | score | (+/−) |
| 32 | Oven | 60 | 30 | 0.00 | 1.50 | A | 3.5 | + |
| 33 | Oven | 100 | 10 | 0.00 | 1.57 | B | 3.3 | + |
| 34 | Boiling | 100 | 2.5 | 13.64 | 1.84 | C | 1.7 | − |

Frozen bitter gourd prepared by subjecting bitter gourd to oven heat treatment at 60° C. for 30 minutes and subsequently freezing the treated bitter gourd exhibited physical properties with a drip loss during natural thawing of 0.00% and a change in bulk density relative to fresh product of 1.50. The frozen bitter gourd was given an overall rating of “A” in the sensory evaluation (test batch 32). Frozen bitter gourd prepared by subjecting bitter gourd to oven heat treatment at 100° C. for 10 minutes and subsequently freezing the treated bitter gourd exhibited physical properties with a drip loss during natural thawing of 0.00% and a change in bulk density relative to fresh product of 1.57. The frozen bitter gourd was given an overall rating of “B” in the sensory evaluation (test batch 33). Frozen bitter gourd prepared through treatment according to conventional art (boiling prior to freezing) exhibited physical properties with a drip loss during natural thawing of as high as 13.64%. In the sensory evaluation, the frozen bitter gourd was evaluated as lacking voluminosity and was given an overall rating of “C” (test batch 34).

The results of test batches 32 and 33 revealed that frozen bitter gourd of the present invention can be prepared through dry heat treatment performed by means of an oven at 60 to 100° C. for 10 to 30 minutes.

1. A frozen vegetable subjected to dry heat treatment prior to freezing, the frozen vegetable exhibiting a drip loss during natural thawing of 7.20% or less, the frozen vegetable exhibiting a change in bulk density relative to fresh product of 1.90 or less, wherein
the drip loss during natural thawing is defined by the following equation:
Drip loss during natural thawing (%)=Weight of drip during natural thawing (g)/Weight of frozen product (g)×100, and
the change in bulk density relative to fresh product is defined by the following equation:
Change in bulk density relative to fresh product=Bulk density exclusive of drip after natural thawing (g/ml)/Bulk density of fresh vegetable prepared by processing of raw material (g/ml).

2. The frozen vegetable according to claim 1, wherein the drip loss during natural thawing is 4.70% or less.

3. The frozen vegetable according to claim 1, wherein the change in bulk density relative to fresh product is 1.80 or less.

4. The frozen vegetable according to claim 1, for cooking.

5. A frozen food comprising the frozen vegetable according to claim 1.

6. The frozen food according to claim 5, further comprising an ingredient and/or a flavoring component.

7. The frozen vegetable according to claim 2, wherein the change in bulk density relative to fresh product is 1.80 or less.

8. The frozen vegetable according to claim 2, for cooking.

9. The frozen vegetable according to claim 3, for cooking.

10. A frozen food comprising the frozen vegetable according to claim 2.

11. A frozen food comprising the frozen vegetable according to claim 3.

12. A frozen food comprising the frozen vegetable according to claim 4.

13. The frozen food according to claim 7, further comprising an ingredient and/or a flavoring component.

14. The frozen food according to claim 8, further comprising an ingredient and/or a flavoring component.

15. The frozen food according to claim 9, further comprising an ingredient and/or a flavoring component.

16. The frozen food according to claim 10, further comprising an ingredient and/or a flavoring component.

17. The frozen food according to claim 11, further comprising an ingredient and/or a flavoring component.

18. The frozen food according to claim 12, further comprising an ingredient and/or a flavoring component.
